(19) United States
(12) Patent Application Publication
(10) Pub. No.: US 2019/0113792 A1
(43) Pub. Date: Apr. 18, 2019

(54) LIQUID CRYSTAL PANEL AND METHOD FOR MANUFACTURING LIQUID CRYSTAL PANEL

(71) Applicant: SHARP KABUSHIKI KAISHA, Sakai City, Osaka (JP)

(72) Inventors: HIROAKI ASAGI, Sakai City (JP); ISAMU MIYAKE, Sakai City (JP)

(21) Appl. No.: 16/090,239

(22) PCT Filed: Mar. 28, 2017
(86) PCT No.: PCT/JP2017/012543

§ 371 Date: Sep. 29, 2018

(30) Foreign Application Priority Data
Apr. 1, 2016 (JP) 2016-074428

(51) Int. Cl. G02F 1/13363; G02F 1/1337; G02F 1/1335

(52) U.S. Cl. CPC G02F 1/13363; G02F 1/133711; C09K 19/56; G02F 2001/133638; G02F 1/133514

(57) ABSTRACT

A liquid crystal panel includes a pair of substrates, a liquid crystal layer sandwiched between the pair of substrates, a birefringent retardation layer provided on the liquid crystal layer side of at least one of the pair of substrates, and an alignment film provided in contact with the surface of the retardation layer. The retardation layer is formed of a first polymer material having a first photofunctional group, and the alignment film is formed of a second polymer material having a side-chain second photofunctional group. The first and second photofunctional groups are ones that undergo at least one photoreaction selected from the group consisting of isomerization, dimerization, and Fries rearrangement. The retardation layer further contains the second polymer material with its percentage increasing with the distance from the substrate, and the alignment film further contains the first polymer material with its percentage decreasing with the distance from the substrate.

### TECHNICAL FIELD

Some aspects of the present invention relate to a liquid crystal panel and a method for manufacturing a liquid crystal panel.

This application claims priority to Japanese Patent Application No. 2016-074428, filed in Japan on Apr. 1, 2016, the contents of which are hereby incorporated by reference.

### BACKGROUND ART

A liquid crystal panel, a component of a liquid crystal display, has a structure in which liquid crystal molecules are sandwiched between a pair of substrates. In the liquid crystal display, light emitted from a light source, such as a backlight, changes its state of polarization while passing through the phase of the liquid crystal molecules because of a retardation caused by the birefringence in the liquid crystal molecules. Liquid crystal displays show images by combining these changes in the state of polarization with the function of polarizers in the crossed-Nicols arrangement.

Such liquid crystal displays may have a retardation-providing layer besides the liquid crystal layer in order for the light having passed through the liquid crystal molecules to be in a desired state of polarization. Known examples of such configurations are those described in PTL 1 and 2.

In PTL 1, an alignment film is first formed on a substrate, and then the alignment film is used to align polymerizable liquid crystal monomers. The aligned liquid crystal monomers as a whole exhibit retardation according to the degree of birefringence in the liquid crystal monomers. The liquid crystal monomers are polymerized in this state to give a retardation layer in which the alignment of the liquid crystal monomers is maintained, and then an alignment film is formed once again, on the surface of the retardation layer, to build a multilayer structure of the retardation layer and alignment films. In the liquid crystal panel described in PTL 1, the retardation layer ensures that the light having passed through the liquid crystal molecules is in a desired state of polarization.

In PTL 2, a layer containing a photoreactive liquid crystal polymer is formed on a substrate, and then this layer is irradiated with linearly polarized light and heated in a predetermined range of temperatures to give a retardation film. Such a retardation film combined with a liquid crystal panel ensures that the light having passed through the liquid crystal molecules is in a desired state of polarization.

### CITATION LIST

### Patent Literature

PTL 1: Japanese Patent No. 3881706

PTL 2: Japanese Unexamined Patent Application Publication No. 2015-172756

### SUMMARY OF INVENTION

### Technical Problem

In recent years, liquid crystal panels called “in-cell” type have been studied. The term “in-cell” herein refers to a structure of a liquid crystal panel configured with a pair of substrates and a liquid crystal layer sandwiched therebetween, the structure in which the optical elements, such as polarizers and a retardation layer, are on the liquid crystal layer side of the substrates, or inside a liquid crystal cell. An “in-cell” liquid crystal panel not only contributes to making a device thin, slim, and lightweight, but also improves the display performance of the device.

When a retardation layer is placed inside the liquid crystal cell of an in-cell liquid crystal panel, the liquid crystal cell is configured using a substrate with a stack of the retardation layer and an alignment film for the liquid crystal layer thereon. A substrate having such a multilayer structure can be produced by, for example, the method described in PTL 1.

Alternatively, the retardation film described in PTL 2 may be attached to the inside of a substrate.

In the method of PTL 1, however, the process is complicated because forming the retardation layer requires a separate step of forming an alignment film. In a complicated process, there is increased risk of impurities getting mixed in with the resulting films, affecting the production yield. Moreover, the alignment film for the formation of the retardation layer makes no optical contribution by itself, but on the other hand it has caused increased total thickness of the liquid crystal cell, an issue that needs to be solved.

When the retardation film of PTL 2 is attached to the inside of a substrate, a problem arises with the relationship between it and the alignment film the liquid crystal panel has. That is, in a setting in which a retardation film formed of a liquid crystal polymer also serves as the alignment film, the direction of the retardation is the same as the direction in which the liquid crystals are aligned. The range of configurations the liquid crystal panel can be in is therefore limited, and structural preparation to achieve practical display performance is impossible. In a setting in which the retardation film does not serve as the alignment film, an alignment film needs to be formed separately on the surface of the retardation film. In this case, however, it is easy to expect that the materials used during the formation of the alignment film, such as solvent, light, and heat, have adverse effects on the characteristics of the retardation film.

Some aspects of the present invention were made in view of these circumstances and have as an object to provide a liquid crystal panel with a novel, thin and slim configuration. Another object is to provide a method for manufacturing a liquid crystal panel whereby such a liquid crystal panel can be manufactured easily.

### Solution to Problem

According to a first aspect of the present invention, a liquid crystal panel is provided that includes a pair of substrates, a liquid crystal layer sandwiched between the pair of substrates, a birefringent retardation layer provided on the liquid crystal layer side of at least one of the pair of substrates, and an alignment film provided in contact with the surface of the retardation layer. The retardation layer is formed of a first polymer material having a first photofunctional group, and the alignment film is formed of a second polymer material having a side-chain second photofunctional group. The first and second photofunctional groups are groups that undergo at least one photoreaction selected from the group consisting of isomerization, dimerization, and Fries rearrangement. The retardation layer further contains the second polymer material with the percentage thereof increasing with the distance from the substrate, and the alignment film further contains the first polymer material with the percentage thereof decreasing with the distance from the substrate.

According to a second aspect of the present invention, a method for manufacturing a liquid crystal panel is provided that includes the step of applying, to a substrate, a mixed solution containing a first polymer material having a first photofunctional group and a second polymer material having a side-chain second photofunctional group and then removing the solvent to form a multilayer film including a first coating formed of the first polymer material and a second coating formed of the second polymer material, the step of irradiating the multilayer film with polarized light with a wavelength that causes photoreaction to the first photofunctional group, the step of heating the multilayer film irradiated with polarized light, and the step of irradiating the heated multilayer film with polarized light with a wavelength that causes photoreaction to the second photofunctional group. The first and second photofunctional groups are groups that undergo at least one photoreaction selected from the group consisting of isomerization, dimerization, and Fries rearrangement.

### Advantageous Effects of Invention

According to some aspects of the present invention, it is possible to provide a liquid crystal panel with a novel, thin and slim configuration, and also to provide a method for manufacturing a liquid crystal panel whereby such a liquid crystal panel can be manufactured easily.

### BRIEF DESCRIPTION OF DRAWINGS

FIG. 1 is a cross-sectional diagram schematically illustrating a liquid crystal panel of Embodiment 1.

FIG. 2 is a step diagram illustrating a method according to Embodiment 2 for manufacturing a liquid crystal panel.

FIG. 3 is a step diagram illustrating a method according to Embodiment 2 for manufacturing a liquid crystal panel.

FIG. 4 is a step diagram illustrating a method according to Embodiment 2 for manufacturing a liquid crystal panel.

FIG. 5 is a step diagram illustrating a method according to Embodiment 2 for manufacturing a liquid crystal panel.

FIG. 6 is a step diagram illustrating a method according to Embodiment 2 for manufacturing a liquid crystal panel.

FIG. 7 is a step diagram illustrating a method according to Embodiment 2 for manufacturing a liquid crystal panel.

FIG. 8 is a schematic diagram illustrating a quality of the resulting counter substrate.

FIG. 9 is a step diagram illustrating a method according to Embodiment 2 for manufacturing a liquid crystal panel.

FIG. 10 is a step diagram illustrating a method according to Embodiment 2 for manufacturing a liquid crystal panel.

FIG. 11 is a step diagram illustrating a method according to Embodiment 2 for manufacturing a liquid crystal panel.

FIG. 12 is a cross-sectional diagram schematically illustrating a liquid crystal panel of Embodiment 4.

FIG. 13 is a schematic diagram that explains a liquid crystal display according to Embodiment 5.

FIG. 14 is an explanatory diagram illustrating the advantages of the liquid crystal display.

FIG. 15 is an explanatory diagram illustrating the advantages of the liquid crystal display.

### DESCRIPTION OF EMBODIMENTS

### Embodiment 1

The following describes a liquid crystal panel according to Embodiment 1 of the present invention with reference to the drawings.

It should be understood that in all drawings mentioned hereinafter, the dimensions, proportions, and other details of the individual elements may vary where appropriate for the sake of clarity.

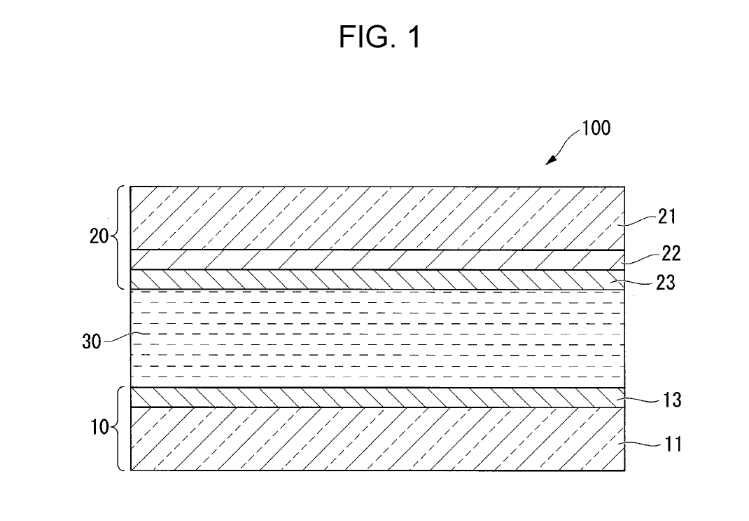

FIG. 1 is a cross-sectional diagram schematically illustrating a liquid crystal panel of this embodiment. As illustrated in FIG. 1, the liquid crystal panel 100 of this embodiment has an element substrate 10, a counter substrate 20, and a liquid crystal layer 30.

The element substrate 10 has a TFT substrate 11 and an alignment film 13 provided on the surface of the TFT substrate 11 on the liquid crystal layer 30 side. The TFT substrate 11 corresponds to part of the “pair of substrate” in an aspect of the present invention.

The TFT substrate 11 has TFT elements for driving, not illustrated. The drain, gate, and source terminals of the driving TFT elements are electrically coupled to a pixel electrode, a gate bus line, and a source bus line, respectively. The pixels are electrically coupled by the electrical wiring of the source and gate bus lines.

When the liquid crystal panel 100 is configured as a transverse-field one, in which liquid crystal molecules are aligned parallel to the substrate plane and a transverse field is applied to the liquid crystal layer, for example in the mode of in-plane switching (IPS) or fringe field switching (FFS), the TFT substrate 11 has a common electrode, not illustrated.

The materials for the individual components of the TFT substrate 11 can be commonly known materials. The semiconductor layer of the driving TFTs is preferably made of IGZO (four-element mixed crystal semiconductor material containing indium (In), gallium (Ga), zinc (Zn), and oxygen (O)). When IGZO is used as a material for a semiconductor layer, the resulting semiconductor layer is limited in charge leakage by virtue of a small off-leakage current. This allows for a longer off period following the application of voltage to the liquid crystal layer. As a result, voltage is applied less frequently during the image display period, and the power consumption of the liquid crystal panel is reduced.

The TFT substrate 11 may be an active matrix one, which has a driving TFT for each pixel, or may be a simple matrix liquid crystal panel, in which not every pixel has a TFT for driving it.

The alignment film 13 has the function of giving liquid crystal molecules in contact with its surface anchoring strength. The material for the alignment film 13 can be a known one, such as polyimide. The alignment film 13 may be a polyimide film rubbed in a predetermined direction to give it the anchoring strength or may be one formed of a material having a photofunctional group and given the anchoring strength through irradiation with light.

The counter substrate 20 has, for example, a color filter substrate 21, a retardation layer 22 provided on the surface of the color filter substrate 21 on the liquid crystal layer 30 side, and an alignment film 23 provided in contact with the retardation layer 22 and on the surface of the retardation layer 22. The color filter substrate 21 corresponds to part of the “pair of substrates” in an aspect of the present invention.

The color filter substrate 21 has, for example, a red color filter layer that absorbs part of incident light and allows red light to pass through, a green color filter layer that absorbs part of incident light and allows green light to pass through, and a blue color filter layer that absorbs part of incident light and allows blue light to pass through.

The color filter substrate 21 may further have an overcoat layer covering its surface to planarize the substrate surface and to prevent the dissolution of colorant materials out of the color filter layers.

The retardation layer 22 is an optical element that is formed of a birefringent material and gives incident linearly polarized light a predetermined retardation. The retardation layer 22 in this embodiment is directly on the surface of the color filter substrate 21, without an intervening alignment film.

The retardation layer 22 is formed of a polymer material having at least one photofunctional group. The material for the retardation layer 22 corresponds to the “first polymer material” in an aspect of the present invention, and the photofunctional group the material for the retardation layer 22 has corresponds to the “first photofunctional group” in an aspect of the present invention.

The first polymer material has at least one selected from the group consisting of a polyimide backbone, a polyamic acid backbone, and a (meth)acrylic backbone as its backbone structure(s).

The first photofunctional group is a group that absorbs light and undergoes at least one photoreaction selected from the group consisting of isomerization, dimerization, and Fries rearrangement. The first photofunctional group can be, for example, at least one selected from the group consisting of a cinnamate group (formula (1) below), an azobenzene group (formula (2) below), and a chalcone group (formula (3) below). The first photofunctional group may be in the backbone structure of the first polymer material or may be in a side chain of the first polymer material, but preferably in a side chain. This helps in the photoreaction and allows for a lower exposure requirement for the initiation of the photoreaction.

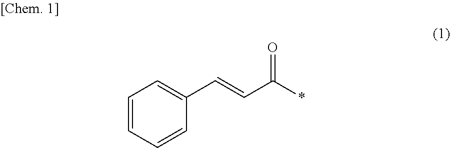 [SMILES: *C(=O)/C=C/c1ccccc1]

(In the formula, the hydrogen atoms may be replaced with a monovalent organic group or fluorine atom.)

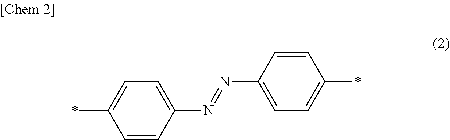 [SMILES: *c1ccc(/N=N/c2ccc(*)cc2)cc1]

(In the formula, the hydrogen atoms may be replaced with a monovalent organic group.)

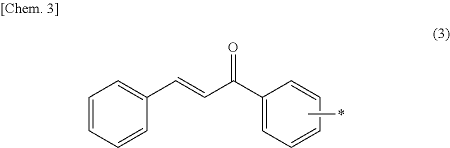

(In the formula, the hydrogen atoms may be replaced with a monovalent group.)

These photofunctional groups undergo photoisomerization or dimerization by absorbing light that falls within their respective absorption bands. To form the retardation layer 22, the first step is to irradiate a coating containing the material for the retardation layer 22 with polarized light. This gives the coating anisotropy according to the directions of polarization and irradiation.

Then, the coating irradiated with polarized light is heated. This facilitates molecular movement of the polymers forming the coating. Inside the coating, the polymers are aligned in a predetermined direction, driven by the anisotropy given to the coating through irradiation with polarized light. In the following description, such a phenomenon of heat-induced alignment may be referred to as “self-assembly.” In this way, the retardation layer 22 can be formed with sufficiently improved orientational order of polymers.

That is, as a result of being formed of the first polymer material and irradiated with polarized light and heated, the retardation layer 22 exhibits a degree of birefringence appropriate for use as a retardation layer.

The alignment film 23 has the function of giving liquid crystal molecules in contact with its surface anchoring strength. The material for the alignment film 23 is a polymer material having at least one side-chain photofunctional group. The material for the alignment film 23 corresponds to the “second polymer material” in an aspect of the present invention, and the photofunctional group the material for the alignment film 23 has corresponds to the “second photofunctional group” in an aspect of the present invention.

The second polymer material has at least one selected from the group consisting of a polyimide backbone, a polyamic acid backbone, a (meth)acrylic backbone, and a siloxane backbone (formula (4) below) as its backbone structure(s). In particular, a siloxane backbone is preferred for use as a backbone structure of the second polymer material.

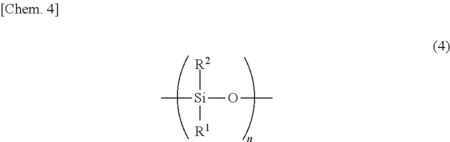

(In the formula, R¹ and R² denote a monovalent organic group.)

The second photofunctional group is a group that absorbs light and undergoes at least one photoreaction selected from the group consisting of isomerization, dimerization, and Fries rearrangement. The second photofunctional group can be, for example, at least one selected from the group consisting of a chalcone group (formula (3) above), a coumarin group (formula (5) below), a cinnamate group (formula (1) above), an azobenzene group (formula (2) above), and a stilbene group (formula (6) below).

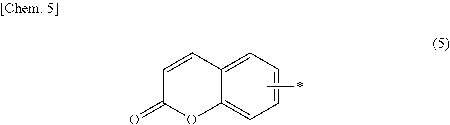

(In the formula, the hydrogen atoms may be replaced with a monovalent organic group.)

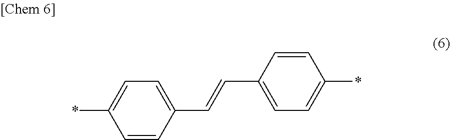 [SMILES: *c1ccc(/C=C/c2ccc(*)cc2)cc1]

(In the formula, the hydrogen atoms may be replaced with a monovalent organic group.)

The second photofunctional group may be directly connected to the silicon atom in the aforementioned siloxane backbone or may be contained in a side chain connected to the silicon atom. Preferably, the second photofunctional group is contained in a side chain. This helps in the photoreaction and allows for a lower exposure requirement for the initiation of the photoreaction. Not all side chains need to contain a photofunctional group. Non-photoreactive side chains, such as a polymerizable functional group that cross-links thermally, may be contained to improve thermal and chemical stability.

These photofunctional groups undergo photoisomerization or dimerization by absorbing light that falls within their respective absorption bands. As a result, the second photofunctional group absorbs polarized light with a second wavelength and undergoes a structural change, and the alignment film 23 restricts the orientation of the liquid crystal molecules in contact with its surface to a given direction. That is, the alignment film 23 is capable of restricting the orientation of liquid crystal molecules to a given direction according to the direction in which it is irradiated with the polarized light with a second wavelength during formation.

It should be understood that the second photofunctional group may be the same functional group(s) as the first photofunctional group. The second and first wavelengths may be the same wavelength.

Such a polymer material can be, for example, a polymer material like the one illustrated in formula (7) below.

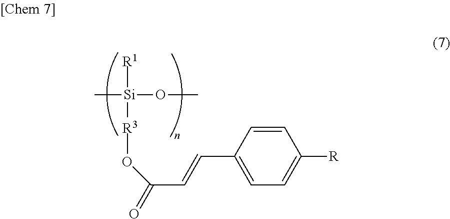

(In the formula, R¹ denotes a monovalent organic group. R³ denotes a single bond or divalent organic group. R denotes a hydrogen atom, fluorine atom, or monovalent organic group. n denotes an integer of 2 or more.)

In the counter substrate 20 in this embodiment, the retardation layer 22 further contains the second polymer material, with the percentage of the material increasing with the distance from the color filter substrate 21. The alignment film 23 further contains the first polymer material, with the percentage of the material decreasing with the distance from the color filter substrate 21. How to produce a counter substrate 20 with such a configuration will be described later herein.

The form of presence of the second polymer material in the retardation layer 22 and that of the first polymer material in the alignment film 23 can be identified by time-of-flight secondary ion mass spectrometry (TOF-SIMS).

For example, the resulting multilayer film including the retardation and alignment-film layers may be subjected to repeated TOF-SIMS and gas cluster ion beam (GCIB) sputtering. This gives the distribution of the first and second polymers forming the multilayer film in the direction of depth.

The liquid crystal layer 30 contains liquid crystal molecules. The liquid crystal molecules may be, for example, positive liquid crystals, which exhibit a positive dielectric anisotropy, or may be negative liquid crystals, which exhibit a negative dielectric anisotropy. The liquid crystal molecules in a no-voltage state are given an orientation determined by the anchoring strength of the alignment films 13 and 23.

Additionally, the liquid crystal panel 100 may have a seal section sandwiched between the element substrate 10 and counter substrate 20 and surrounding the liquid crystal layer 30 and/or a spacer, a pillar-like structure for limiting the thickness of the liquid crystal layer 30.

A liquid crystal panel configured as such is one with a thin and slim configuration by virtue of having no alignment film between the retardation layer 22 and color filter substrate 21.

### Embodiment 2

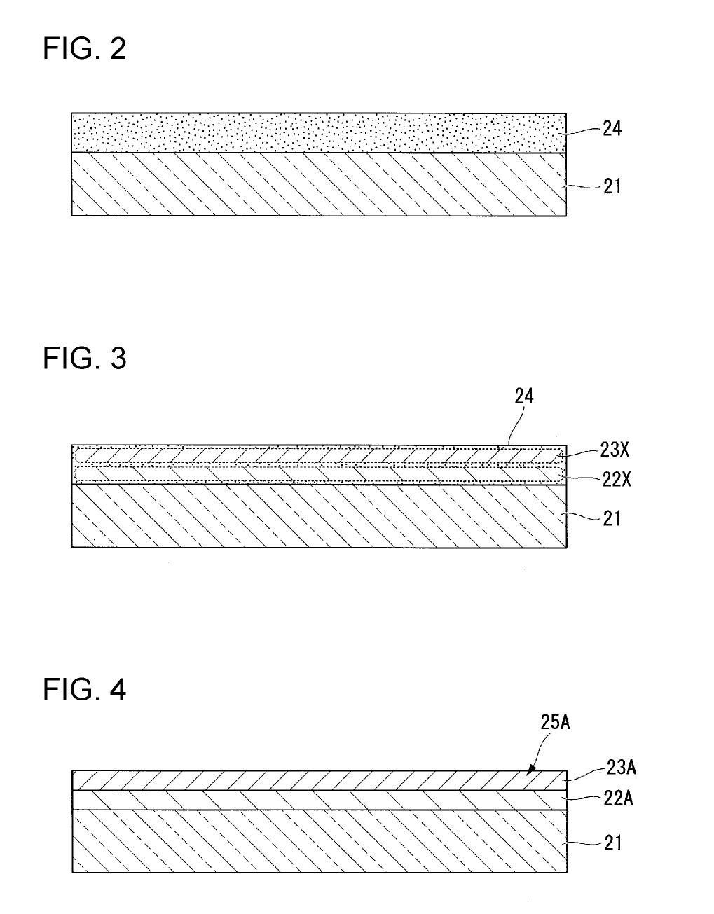

FIGS. 2 to 11 are step diagrams illustrating a method according to Embodiment 2 of the present invention for manufacturing a liquid crystal panel. In the following description, a manufacturing method of this embodiment is portrayed by detailing steps for the production of the counter substrate 20 used in the liquid crystal panel illustrated in FIG. 1. The structural elements this embodiment has in common with Embodiment 1 remain assigned the same numerals and are not described in detail.

First, as illustrated in FIG. 2, a solution containing a first polymer material having a first photofunctional group, and a second polymer material having a second photofunctional group is applied to a color filter substrate 21 to form a coating 24.

In this step, it is preferred to use a combination of first and second polymer materials with which even if irradiation with polarized light with a first wavelength causes a structural change to the first photofunctional group in the first polymer material, the second photofunctional group in the second polymer material does not undergo a photoreaction, is unlikely to undergo a photoreaction, or, even through it undergoes a photoreaction, returns to the state before the light irradiation in a subsequent heating step by virtue of the heat counteracting the change caused by the photoreaction. In this embodiment, first and second polymer materials having such physical properties are used.

The first polymer material can be the same as that described above. The polymer used here has a polyamic acid backbone structure and backbone azobenzene groups as the first photofunctional group.

The second polymer material can be the same as that described above. The polymer used here has a siloxane backbone structure and side-chain cinnamate groups as the second photofunctional group.

In this embodiment, the solution applied is a solution of the first and second polymer materials in a 1:1 solvent mixture of N-methylpyrrolidone and ethylene glycol monobutyl ether. In this solution, the first and second polymer materials are dissolved to a mass ratio of 10:1. The concentration on a solids basis of the solution is, for example, 15% by mass.

The application of the solution can be done by various known methods as long as a coating can be obtained with the desired thickness. Examples include spin coating, bar coating, ink jetting, slit coating, and screen printing. In this embodiment, spin coating is used to apply the solution.

Then, as illustrated in FIG. 3, the solvent is removed by allowing the coating 24 to stand still or heating it at low temperatures. The coating 24 gradually separates into two layers, a first coating 22X and a second coating 23X, because of the physical properties of the first and second polymer materials.

The first coating 22X contains the first polymer material. The second coating 23X contains the second polymer material. For such a separation to take place in a suitable manner, it is preferred that the surface energy of the second polymer material be smaller than that of the first polymer material, that the molecular weight of the second polymer material be lower than that of the first polymer material, or that the specific gravity of the first polymer material be lower than that of the first polymer material. When a property of the first polymer material and that of the second polymer material satisfy such a relationship, it is easier to achieve the separation into two layers shortly after the solution is applied and allowed to stand still.

The aforementioned characteristics of the first and second polymer materials can be adjusted by controlling the degree of polymerization and side-chain structure of each polymer material.

Then, as illustrated in FIG. 4, a multilayer film 25A is formed in which the first coating 22A and second coating 23A are stacked. The multilayer film 25A corresponds to the multilayer film in an aspect of the present invention.

During the separation into two layers, drying may be accelerated by removing the solvent through standing, heating, vacuuming, air-drying, and a combination thereof. For example, heating the applied solution at 60° C. for 5 minutes (prebaking) accelerates the separation into two layers while removing the solvent. The thickness of the resulting first coating 22A is, for example, 2000 nm, and that of the resulting second coating 23A is, for example, 200 nm. In the following description, the drying process that gives the first coating 22A and second coating 23A may be referred to as “initial drying.”

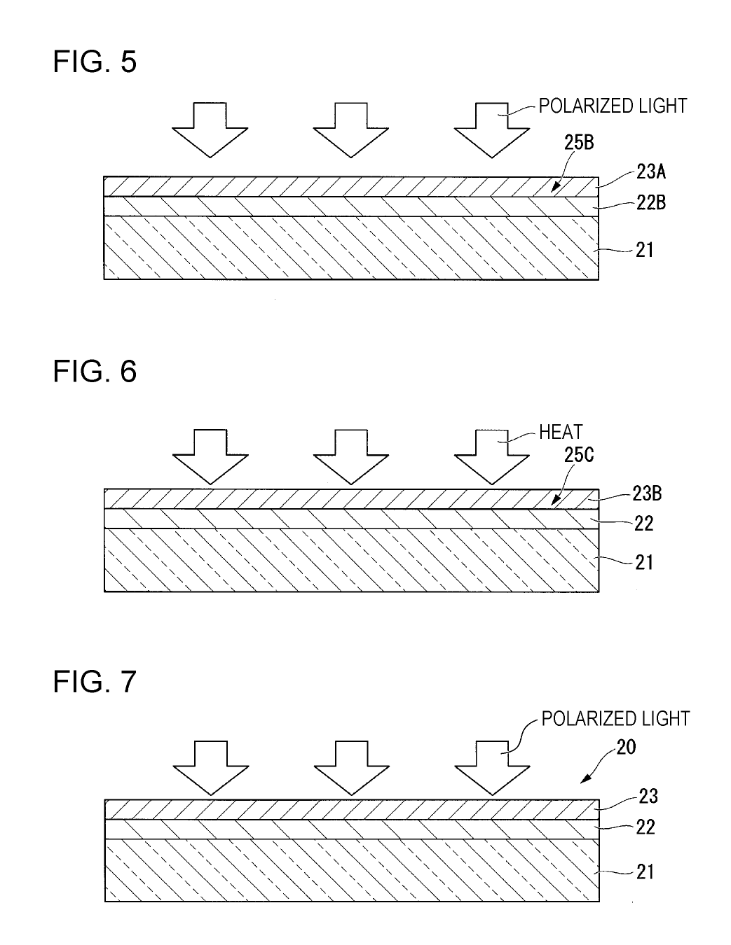

Then, as illustrated in FIG. 5, the resulting multilayer film is irradiated with polarized light (polarized light with a first wavelength). For example, the multilayer film is exposed to 1 J/cm² of ultraviolet radiation with a peak wavelength of 365 nm in the direction normal to the substrate.

It should be noted that this embodiment uses a combination of first and second polymer materials with which even if the irradiation with polarized light with a first wavelength causes a structural change to the first photofunctional group in the first polymer material, the second photofunctional group in the second polymer material does not undergo a photoreaction or is unlikely to undergo a photoreaction. Thus, the exposure to polarized light causes a structural change to the first photofunctional group in the first coating 22A, turning it into a first coating 22B, which has an in-plane retardation. In the second coating 23A, however, the exposure to polarized light produces no structural change. In this way, a multilayer film 25B is obtained.

Then, as illustrated in FIG. 6, the multilayer film irradiated with polarized light is heated, for example at 200° C. for 60 minutes using a clean oven. This accelerates the self-assembly of the first polymer material, causing a large in-plane retardation to develop. Together with this, the polyamic acid that provides the backbone structure of the first polymer material undergoes intramolecular cyclization into polyimide, yielding a retardation layer 22. At the same time, in the second polymer material, the residual solvent left after incomplete evaporation during the aforementioned initial drying process evaporates fully. When the second polymer material has a side-chain polymerizable functional group that cross-links thermally, cross-linking is accelerated, producing a stable polymer film. In this way, a second coating 23B is obtained, and a multilayer film 25C is obtained.

Then, as illustrated in FIG. 7, the heated multilayer film is irradiated with polarized light (polarized light with a second wavelength). For example, the multilayer film is exposed to 20 mJ/cm² of ultraviolet radiation with a peak wavelength of 313 nm. The polarization axis of the ultraviolet radiation emitted crosses that of the polarized light with a first wavelength, emitted during the formation of the retardation layer 22, in plan view. For example, the polarization axis of the ultraviolet radiation emitted crosses at an angle of 45° in plan view that of the polarized light emitted during the formation of the retardation layer 22.

Moreover, the polarized light with which the heated multilayer film is irradiated is at an intensity that does not destroy the orientational order in the retardation layer 22. For example, if the polarized light emitted in FIG. 7 is 500 mJ/cm² of ultraviolet radiation with a wavelength of 254 nm, the ultraviolet radiation disturbs the orientational order in the retardation layer 22 and makes it no longer function as a retardation layer 22, although the desired alignment film 23 is formed. For the intensity and dose of the polarized light emitted, the manufacturer can perform a preliminary experiment as needed to find a light intensity at which the alignment film 23 can be obtained while keeping the orientational order in the retardation layer 22.

This produces a difference between the anchoring strength in the same direction as the polarization axis emitted and that in the direction perpendicular to the polarization axis of the polarized light in the second coating 23B, yielding an alignment film 23. In this way, the counter substrate 20 is formed.

For example, if the retardation layer 22 and alignment film 23 were formed and stacked one by one on a color filter substrate 21, the retardation layer 22 would contain no second polymer material, and the alignment film 23 would contain no first polymer material. In such a one-by-one approach, therefore, measuring the first polymer material content in the retardation layer 22 and alignment film 23 along the direction of thickness would find discontinuous first polymer material concentrations at the interface between the retardation layer 22 and alignment film 23. Likewise, measuring the second polymer material content in the retardation layer 22 and alignment film 23 along the direction of thickness would find discontinuous second polymer material concentrations at the interface between the retardation layer 22 and alignment film 23. The resulting layer and film would therefore be different from the retardation layer 22 and alignment film 23 in an aspect of the present invention.

By contrast, in a counter substrate 20 whose layer structure is formed by a production process like the foregoing, the retardation layer 22 further contains the second polymer material, with the percentage of the material increasing with the distance from the color filter substrate 21, and the alignment film 23 further contains the first polymer material, with the percentage of the material decreasing with the distance from the color filter substrate 21.

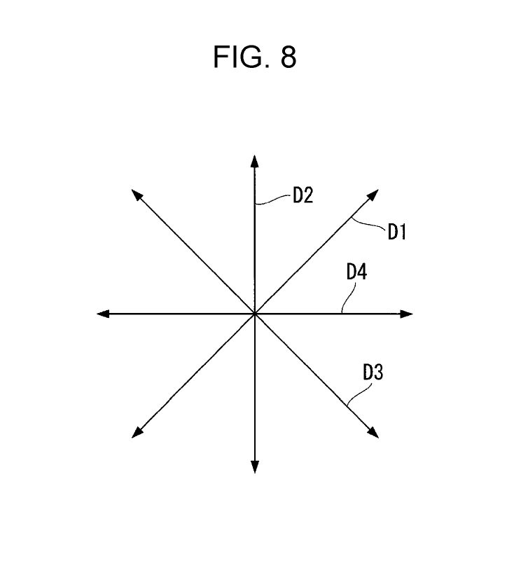

FIG. 8 is a schematic diagram illustrating a quality of a counter substrate 20 obtained in such a way, the counter substrate 20 as viewed in the direction normal to the substrate.

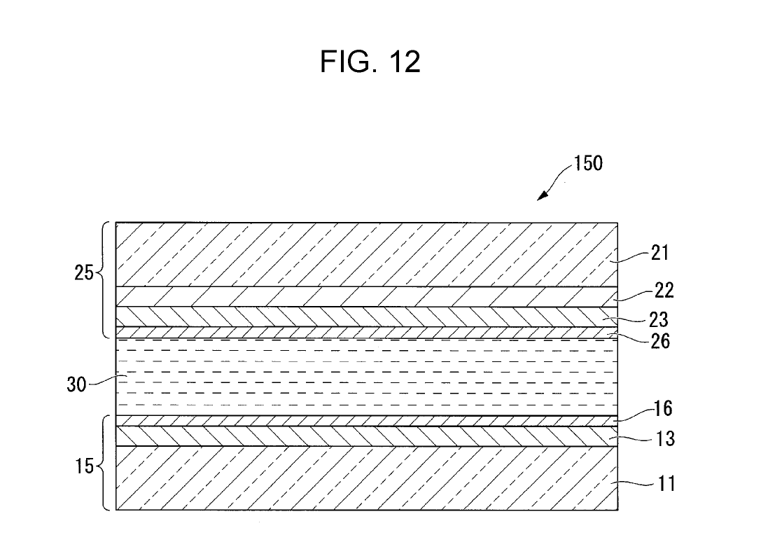

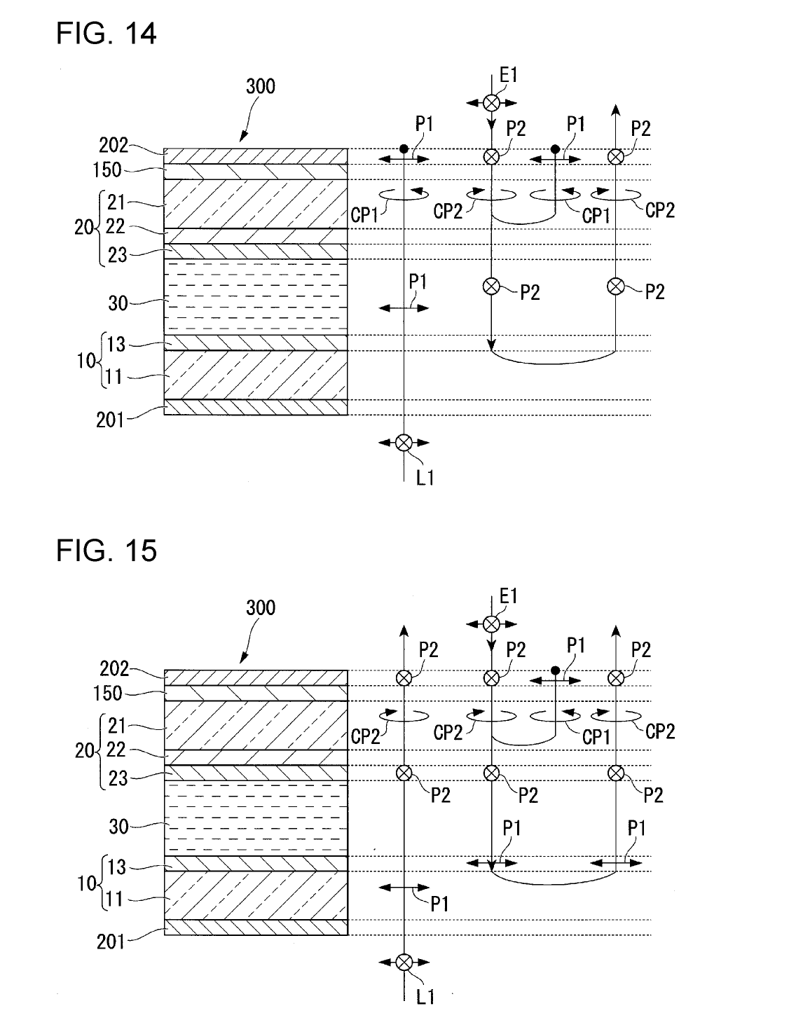

As illustrated, for example, when the direction of the polarization axis of the polarized light emitted in FIG. 12 is defined as the sign D1, the slow axis of the resulting retardation layer 22 is in the direction of the sign D3. When the direction of the polarization axis of the polarized light emitted in FIG. 14 is defined as the sign D2, which crosses the sign D1 at an angle of 45°, the orientation of liquid crystal molecules in the resulting alignment film 23 is in the direction of the sign D4.

The alignment film 13 on the element substrate side 10, illustrated in FIG. 1, can also be produced using the solution containing first and second polymer materials.

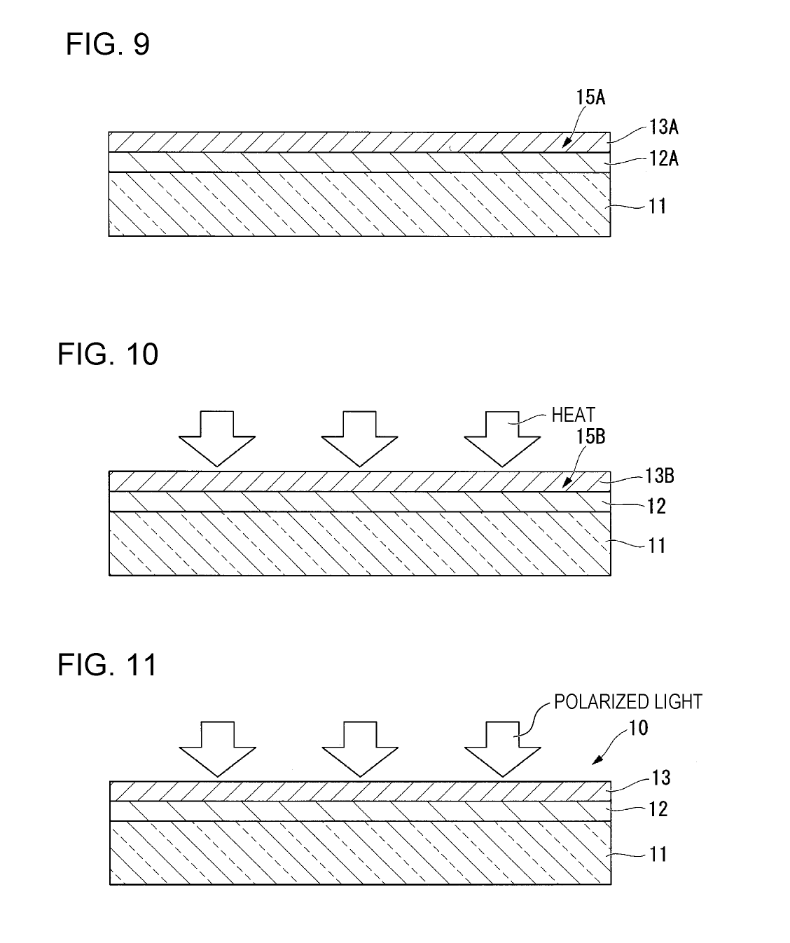

As illustrated in FIG. 9, the solution containing first and second polymer materials is applied to the surface of a TFT substrate 11 and dried by standing or initial firing to form a multilayer film 15A including a first coating 12A and a second coating 13A. The first coating 12A has the same composition as the aforementioned first coating 22A, and the second coating 13A has the same composition as the aforementioned second coating 23A.

Then, as illustrated in FIG. 10, the multilayer film is heated, for example at 200° C. for 60 minutes. This makes the polyamic acid providing the backbone structure of the first polymer material undergo intramolecular cyclization into polyamide, giving a first coating 12. The first coating 12 is a film that exhibits no optical activity. At the same time, in the second polymer material, the residual solvent left after incomplete evaporation during the initial drying process evaporates fully. When the second polymer material has a side-chain polymerizable functional group that cross-links thermally, cross-linking is accelerated, producing a stable polymer film. In this way, a second coating 13B is obtained, and a multilayer film 15B is obtained.

Then, as illustrated in FIG. 11, the heated multilayer film is irradiated with polarized light (polarized light with a second wavelength). For example, the multilayer film is exposed to 20 mJ/cm² of ultraviolet radiation with a peak wavelength of 313 nm. This produces a difference between the anchoring strength in the same direction as the polarization axis emitted and that in the direction perpendicular to the polarization axis of the polarized light in the second coating 13B, yielding an alignment film 13. In this way, the element substrate 10 is formed.

Then, liquid crystal molecules are sandwiched between the resulting element substrate 10 and counter substrate 20 by a known method, giving a liquid crystal panel.

With a method configured as such for manufacturing a liquid crystal panel, it is easy to produce a liquid crystal panel with a thin and slim configuration, having no alignment film between the retardation layer 22 and color filter substrate 21.

### Embodiment 3

Although in Embodiment 2 the first photofunctional group, which the first polymer material has, and the second photofunctional group, which the second polymer material has, are different, this is not the only option. The following describes a method according to Embodiment 3 for manufacturing a liquid crystal panel, referring to FIGS. 2 to 7 and 9 to 11 where necessary.

In this embodiment, for example, the first polymer material is a polymer having a polymethacrylate backbone structure and side-chain cinnamate groups as the first photofunctional group. The second polymer material is a polymer having a siloxane backbone structure and side-chain cinnamate groups as the second photofunctional group.

In this case, as in Embodiment 2, a solution containing the first polymer material, which has the first photofunctional group, and the second polymer material, which has the second photofunctional group, to a color filter substrate 21, and the solvent is removed from the resulting coating, as illustrated in FIGS. 2 and 3. This forms the multilayer film 25A illustrated in FIG. 4, in which a first coating 22A and a second coating 23A are stacked. The thickness of the first coating 22A is, for example, 1500 nm.

Then, as illustrated in FIG. 5, the resulting multilayer film is irradiated with polarized light (polarized light with a first wavelength). For example, the multilayer film is exposed to 5 mJ/cm² of ultraviolet radiation with a peak wavelength of 313 nm in the direction normal to the substrate.

Then, as illustrated in FIG. 6, the multilayer film is heated at 180° C. for 30 minutes after the irradiation with polarized light. This causes polymer self-assembly properties to develop in the multilayer film, yielding a retardation layer 22 with increased orientational order.

Then, 20 mJ/cm² of ultraviolet radiation with a peak wavelength of 313 nm is emitted as the polarized light emitted in the operation illustrated in FIG. 7. As described above, this gives an alignment film 23.

Even with such a combination of materials, it is easy to produce a liquid crystal panel with a thin and slim configuration, having no alignment film between the retardation layer 22 and color filter substrate 21.

In a manufacturing method of this embodiment, moreover, no solvent comes into contact with the retardation layer 22 after the formation of the retardation layer 22, even when the retardation layer 22 is formed of an acrylic polymer material, highly soluble in solvents compared with polyimide. This controls the deterioration in quality of the retardation layer that occurs during the production process.

Furthermore, the first polymer material used gives a retardation layer 22 good in light transmittance by virtue of high transparency of the polymethacrylate that provides the backbone structure. As a result, the resulting liquid crystal panel has a high light transmittance.

### Embodiment 4

FIG. 12 is a cross-sectional diagram schematically illustrating a liquid crystal panel 150 of Embodiment 4 and is a drawing corresponding to FIG. 1. As illustrated in FIG. 12, the liquid crystal panel 150 of this embodiment has an element substrate 15, a counter substrate 25, and a liquid crystal layer 30.

The element substrate 15 has an alignment sustaining layer 16 provided on the surface of the alignment film 13 on the liquid crystal layer 30 side. The counter substrate 25 has an alignment sustaining layer 26 provided on the surface of the alignment film 23 on the liquid crystal layer 30 side.

The alignment sustaining layers 16 and 26 are formed of a photopolymerizable substance and have the function of defining the function of restricting the orientation of liquid crystal molecules in the liquid crystal layer 30, thereby improving the anchoring strength, while no voltage is applied to the liquid crystal layer 30. The alignment sustaining ce layers 16 and 26 are formed of, for example, a material obtained by adding 0.5% by mass biphenyl-4,4′-diyl-bis(2-methylacrylate), as a polymerizable monomer, to 100% by mass the liquid crystal molecules used in the liquid crystal layer 30. The polymerizable monomer, added in the small amount of 0.5% by mass to the liquid crystal molecules in the liquid crystal layer 30, forms alignment sustaining layers on the surface of the alignment films that seem as if the monomer piled up there.

In a liquid crystal panel including the liquid crystal layer 30 with the polymerizable monomer added thereto, the alignment sustaining layers 16 and 26 are obtained by irradiating the panel in a no-voltage state with 2 J/cm² of ultraviolet radiation having its central wavelength near 350 nm.

Having such alignment sustaining panels 16 and 26, the liquid crystal panel 150 is a high-quality one that offers the advantages of an aspect of the present invention plus reduced screen burn.

### Embodiment 5

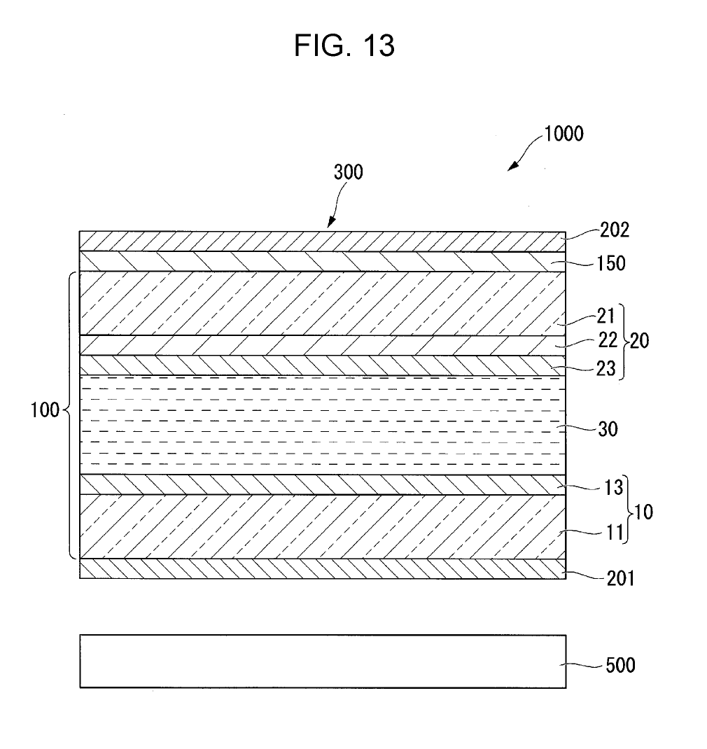

FIGS. 13 to 15 are schematic diagrams that explain a liquid crystal display 1000 having a liquid crystal panel as described above.

As illustrated in FIG. 13, the liquid crystal display 1000 has a liquid crystal panel 300 and a backlight 500 provided on the element substrate 10 side of the liquid crystal panel 300.

The liquid crystal panel 300 has a liquid crystal panel 100 as described above, a retarder 150 provided on the surface of the counter substrate 20 of the liquid crystal panel 100, a polarizer 201 provided on the surface of the element substrate 10 of the liquid crystal panel 100, and a polarizer 202 provided on the surface of the retarder 150.

The retarder 150 is a λ/4 retarder. The retarder 150 can be a known one.

The polarizers 201 and 202 can be ones with a commonly known configuration. The polarizers 201 and 202 are in, for example, the crossed-Nicols arrangement.

Moreover, the transmission axes of the polarizers 201 and 202, perpendicular to each other, cross the slow axes of the retardation layer 22 and retarder 150 at 45° in plan view.

For such a liquid crystal display 1000, the display screen is viewed from the counter substrate 20 side.

FIGS. 14 and 15 are explanatory diagrams illustrating the advantages of the liquid crystal display 1000.

First, as illustrated in FIG. 14, for the liquid crystal display 1000 to show black, light L1, which is natural light emitted from a backlight not illustrated, becomes linearly polarized light P1 by passing through the polarizer 201 and enters into the liquid crystal panel 100. In the liquid crystal panel 100, the linearly polarized light P1 passes through the element substrate 10, uncharged liquid crystal layer 30, and alignment film 23.

When the linearly polarized light P1 passes through the retardation layer 22, the linearly polarized light P1 is converted, for example into right circularly polarized light CP1. The right circularly polarized light CP1 passes through the color filter substrate 21 and then is converted again at the retarder 150, into linearly polarized light P1. The linearly polarized light P1 is blocked by the crossed-Nicol polarizer 202, and black is shown.

External light E1, which is natural light that strikes the liquid crystal display 1000 while it is showing black, becomes linearly polarized light P2 by passing through the polarizer 202. The linearly polarized light P1 and linearly polarized light P2 have perpendicular polarization axes. The linearly polarized light P2 is converted into left circularly polarized light CP2 at the retarder 150.

If reflected off the interfaces in the counter substrate 20 without entering into the retardation layer 22, the left circularly polarized light CP2 becomes right circularly polarized light CP1. The right circularly polarized light CP1 is converted into linearly polarized light P1 at the retarder 150. The linearly polarized light P1 is blocked by the crossed-Nicol polarizer 202.

If entering into the retardation layer 22, the left circularly polarized light CP2 is converted again, into linearly polarized light P2. The linearly polarized light P2 is converted again, into left circularly polarized light CP2, if reflected off the interfaces located on the counter substrate 20 side with respect to the retardation layer 22 and entering into the retardation layer 22 once again. The left circularly polarized light CP2 is converted again at the retarder 150, into linearly polarized light P2, and passes through the polarizer 202.

The components of the external light that reflect off the interfaces located on the counter substrate 20 side with respect to the retardation layer 22, however, lose their intensity by passing through the polarizer 202 and color filter substrate 21 twice. The intensity of the external light returning to the viewer's side therefore decreases greatly, and the visibility loss associated with external light is reduced.

Then, as illustrated in FIG. 15, for the liquid crystal display 1000 to show white, light L1, which is natural light emitted from a backlight not illustrated, becomes linearly polarized light P1 by passing through the polarizer 201 and turns into linearly polarized light P2 by passing through the liquid crystal layer 30.

When the linearly polarized light P2 passes through the retardation layer 22, the linearly polarized light P2 is converted, for example into left circularly polarized light CP2. The left circularly polarized light CP2 passes through the color filter substrate 21 and then is converted again at the retarder 150, into linearly polarized light P2. The linearly polarized light P2 passes through the crossed-Nicol polarizer 202, and white is shown.

External light E1, which is natural light that strikes the liquid crystal display 1000 while it is showing white, becomes linearly polarized light P2 by passing through the polarizer 202 and is converted into left circularly polarized light CP2 at the retarder 150.

If reflected off the interfaces in the counter substrate 20 without entering into the retardation layer 22, the left circularly polarized light CP2 is blocked by the polarizer 202 as described above.

If entering into the retardation layer 22, the left circularly polarized light CP2 is converted again, into linearly polarized light P2. The linearly polarized light P2 becomes linearly polarized light P1 by passing through the liquid crystal layer 30.

The linearly polarized light P1 becomes linearly polarized light P2 once again by reflecting off the interfaces on the counter substrate 20 side with respect to the retardation layer 22 and passing through the liquid crystal layer 30. The linearly polarized light P2 is converted again, into left circularly polarized light CP2, when returning into the retardation layer 22. The left circularly polarized light CP2 is converted again at the retarder 150, into linearly polarized light P2, and passes through the polarizer 202.

In this case, too, as in the showing of black, the components of the external light that reflect off the interfaces on the counter substrate 20 side with respect to the retardation layer 22 lose their intensity by passing through the polarizer 202 and color filter substrate 21 twice. The intensity of the external light returning to the viewer's side therefore decreases greatly, and the visibility loss associated with external light is reduced.

In consequence, the liquid crystal display 1000 provides good display of images without visibility loss associated with external light.

Having described preferred embodiments of an aspect of the present invention with reference to the accompanying drawings, it goes without saying that the present invention is not limited to these examples. The shapes, combinations, and other details of the individual components presented in the above examples are merely illustrative, and various modifications can be made according to design requirements or other conditions without departing from the spirit of the present invention.

For example, although in the above embodiments the liquid crystal panel 100 is a transparent liquid crystal panel, this is not the only option. A liquid crystal panel according to an aspect of the present invention may be of reflective type, or may even be a semitransparent semireflective one. Alternatively, it may be applied to liquid crystal panels for 3D image display.

### INDUSTRIAL APPLICABILITY

Some aspects of the present invention can be applied to, for example, a liquid crystal panel with a novel, thin and slim configuration and a method for manufacturing a liquid crystal panel whereby such a liquid crystal panel can be manufactured easily.

### REFERENCE SIGNS LIST

21 . . . Color filter substrate; 22 . . . retardation layer; 22A, 22B . . . first coating; 23 . . . alignment film; 23A, 23B . . . second coating; 24 . . . coating; 25A, 25B, 25C . . . multilayer film; 30 . . . liquid crystal layer; 100, 300 . . . liquid crystal panel

1. A liquid crystal panel comprising:
a pair of substrates;
a liquid crystal layer sandwiched between the pair of substrates;
a birefringent retardation layer provided on a liquid crystal layer side of at least one of the pair of substrates; and
an alignment film provided in contact with a surface of the retardation layer, wherein:
the retardation layer is formed of a first polymer material having at least one first photofunctional group;
the alignment film is formed of a second polymer material having at least one side-chain second photofunctional group;
the first and second photofunctional groups are groups that undergo at least one photoreaction selected from the group consisting of isomerization, dimerization, and Fries rearrangement;
the retardation layer further contains the second polymer material with a percentage thereof increasing with distance from the substrate; and
the alignment film further contains the first polymer material with a percentage thereof decreasing with distance from the substrate.

2. The liquid crystal panel according to claim 1, wherein a fast axis of the retardation layer and an axis of alignment, determined by the alignment film, of liquid crystal molecules cross at acute angles in plan view.

3. The liquid crystal panel according to claim 1, wherein the first polymer material has at least one selected from the group consisting of a polyimide backbone, a polyamic acid backbone, and a (meth)acrylic backbone.

4. The liquid crystal panel according to claim 1, wherein the at least one first photofunctional group is at least one selected from the group consisting of a cinnamate group, an azobenzene group, and a chalcone group.

5. The liquid crystal panel according to claim 1, wherein the at least one second photofunctional group is at least one selected from the group consisting of a chalcone group, a coumarin group, a cinnamate group, an azobenzene group, and a stilbene group.

6. The liquid crystal panel according to claim 1, further comprising an alignment sustaining layer in contact with a surface of the alignment layer.

7. The liquid crystal panel according to claim 1, wherein the second polymer material has a siloxane backbone.

8. The liquid crystal panel according to claim 1, wherein:
one of the pair of substrates is a color filter substrate;
the retardation layer and the alignment film are provided on the liquid crystal layer side of the color filter substrate;
a λ/4 retardation layer is provided on a side of the color filter substrate opposite the liquid crystal layer, and
a polarizing layer is provided on a side of the λ/4 retardation layer opposite the color filter substrate.

9. The liquid crystal panel according to claim 1, wherein a display mode of the panel is IPS or FFS mode.

10. A method for manufacturing a liquid crystal panel, the method comprising:
a step of applying, to a substrate, a mixed solution containing a first polymer material having a first photofunctional group and a second polymer material having a side-chain second photofunctional group and then removing solvent to form a multilayer film including a first coating formed of the first polymer material and a second coating formed of the second polymer material;
a step of irradiating the multilayer film with polarized light with a wavelength that initiates photoreaction of the first photofunctional group;
a step of heating the multilayer film irradiated with polarized light, and
a step of irradiating the heated multilayer film with polarized light with a wavelength that initiates photoreaction of the second photofunctional group, wherein
the first and second photofunctional groups are groups that undergo at least one photoreaction selected from the group consisting of isomerization, dimerization, and Fries rearrangement.

11. The method according to claim 10 for manufacturing a liquid crystal panel, wherein a surface energy of the second polymer material is lower than a surface energy of the first polymer material.

12. The method according to claim 10 for manufacturing a liquid crystal panel, wherein a molecular weight of the second polymer material is lower than a molecular weight of the first polymer material.

13. The method according to claim 10 for manufacturing a liquid crystal panel, wherein a specific gravity of the second polymer material is lower than a specific gravity of the first polymer material.
